(19) United States
(12) Patent Application Publication
(10) Pub. No.: US 2010/0174623 A1
(43) Pub. Date: Jul. 8, 2010

(54) System and Method for Managing Items of Interest Selected from Online Merchants

(76) Inventors: MICHAEL MCPHIE, PALO ALTO, CA (US); CARIN WATSON, SAN JOSE, CA (US); AMY MICHAEL, BURLINGAME, CA (US); CALEB WATSON, AUSTIN, TX (US); RAMA KANTIPUDI, AUSTIN, TX (US); COREY COUCH, AUSTIN, TX (US); CRAIG KELLOGG, WINDHAM, ME (US); GEORGE WILLIAM COOMBES, IV, AUSTIN, TX (US); CHARLES WILSON, PALO ALTO, CA (US)

Correspondence Address: AFS/ VISA, 666 THIRD AVENUE , 10TH FLOOR, NEW YORK, NY, 10017, US

(21) Appl. No.: 12/683,802

(22) Filed: Jan. 7, 2010

Related U.S. Application Data
(60) Provisional application No. 61/143,090, filed on Jan. 7, 2009.

(51) Int. Cl. G06Q 30/00; G06Q 99/00; G06F 15/16; G06F 3/048

(52) U.S. Cl. 705/27; 705/347; 709/206; 715/860

(57) ABSTRACT

A system for managing wish list items from a plurality of online merchants is provided. The system includes a memory, processor and item management module executed by the processor. The memory stores data regarding the wish list items that have been selected by a user while browsing online merchant websites. The item management module has a receive-advice feature that sends an electronic message to user-selected contacts. The electronic message contains a request for feedback on one or more selected items of interest. When the contacts submit feedbacks, they are stored in the memory for viewing by the user.

### CROSS-REFERENCE TO RELATED APPLICATIONS

This application claims priority under 35 U.S.C. §119 to U.S. provisional patent application Ser. No. 61/143,090, filed Jan. 7, 2009, which is incorporated herein by reference.

### FIELD OF THE INVENTION

The present invention relates to e-commerce data processing systems, and in particular relates to a system and method of managing items of interest that have been selected from online merchants.

### BACKGROUND OF THE INVENTION

Online shopping through a public computer network such as the Internet has been growing exponentially over the past decade due to its convenience and competitive prices. However, its growth is expected to slow as most people have already become familiar with the Internet and online shopping. To encourage more sales, one feature that online merchants have been offering is a wish list feature in which a shopper can save details of items that may be of some interest for later purchase.

However, many items in the wish list are never purchased because the shopper is unsure about those items and there is no convenient way to receive any comments from the shopper's friends and colleagues who might provide an encouragement to buy.

Therefore, it would be desirable to provide a convenient system and method for allowing shoppers to request and receive feedback on their wish list items from friends and colleagues. It would also be desirable to allow shoppers to add items to the wish list from multiple online merchants that are unrelated to each other.

### SUMMARY OF THE DISCLOSURE

According to one embodiment of the invention, a system for managing wish list items from a plurality of online merchants is provided. The system includes a memory, processor and item management module executed by the processor. The memory stores data regarding the wish list items that have been selected by a user. The item management module has a receive-advice feature that sends an electronic message to user-selected contacts. The electronic message contains a request for feedback on one or more selected items of interest. When the contacts submit feedbacks, they are stored in the memory for viewing by the user.

In another embodiment, a method for managing items of interest for potential purchase from a plurality of online merchants is provided. The method includes storing data regarding wish list items which are selected by a user, sending an electronic message to one or more user-selected contacts containing a request for feedback on one or more selected items of interest, and storing the feedback from the contacts in the memory.

As can be appreciated, the present invention provides a convenient system and method for a shopper to request and receive feedbacks on his wish list items from friends and colleagues. In this way, the shoppers make purchases with confidence knowing that the items being purchased have received positive feedback and the online merchants benefit from increased sales.

### BRIEF DESCRIPTION OF THE DRAWINGS

FIG. 1 illustrates an exemplary computing environment under which the present invention operates.

FIG. 2 is a block diagram of a system for managing items of interest for potential purchase according to an embodiment of the present invention.

FIG. 3 is a block diagram of an exemplary user computer according to an embodiment of the present invention.

FIG. 4 is a flowchart of steps for adding items of interest to the user's wish list according to an embodiment of the present invention.

FIG. 5A is a representative screenshot of a web page of an online merchant when a user wishes to add an item of interest to a wish list while browsing according to an embodiment of the present invention.

FIG. 5B is a representative screenshot of the web page of FIG. 5A including an overlay for adding an item of interest to a wish list according to an embodiment of the present invention.

FIG. 6A is a flowchart of steps for requesting feedback on selected items of interest according to an embodiment of the present invention.

FIG. 6B is a flowchart of steps for obtaining feedback on items of interest from a user's contact according to an embodiment of the present invention.

FIG. 7A is a representative screenshot of a web page displaying items of interest which have been added by a user according to an embodiment of the present invention.

FIG. 7B is a representative screenshot of a zoomed portion of the web page of FIG. 7A displaying one cluster of related items of interest according to an embodiment of the present invention.

FIG. 7C is a screenshot of the web page of FIG. 7B including an overlay for requesting a feedback according to an embodiment of the present invention.

FIG. 8A is a representative email message received by a user-specified contact according to an embodiment of the present invention.

FIG. 8B is a representative screenshot of a web page displaying items of interest for which the user has requested a feedback according to an embodiment of the present invention.

FIG. 8C is a representative email to the user indicating that the user-specified contact has provided a feedback on an item according to an embodiment of the present invention.

FIG. 8D is a representative screenshot of a web page displaying items of interest which contain feedback ratings for the associated items according to an embodiment of the present invention.

FIG. 8E is a representative screenshot of a web page and an overlay which displays details of a selected item and its feedback from the user's contacts according to an embodiment of the present invention.

### DETAILED DESCRIPTION OF THE INVENTION

For purposes of this application, the terms “code”, “program”, “application”, “software code”, “software module”, “module” and “software program” are used interchangeably to mean software instructions that are executable by a processor.

The present system allows a user/shopper to browse any online merchant's website on the Internet and add items of interest to his “Wishspace”. Once the items are added, the system allows the user to request feedback on any item of interest from his contacts. Feedbacks can include a rating of an item and comment on the item.

In one embodiment, as described in detail below, the system includes a plug-in module which is designed to be run inside a user's browser program and which may be activated to access certain features such as data capturing and graphical interface to make it easy to add items of interest from multiple unassociated merchants.

As can be appreciated, the present system is beneficial for the shoppers as it helps them to make decisions on particular items. The system is also helpful to the merchants as it will likely result in increased sales.

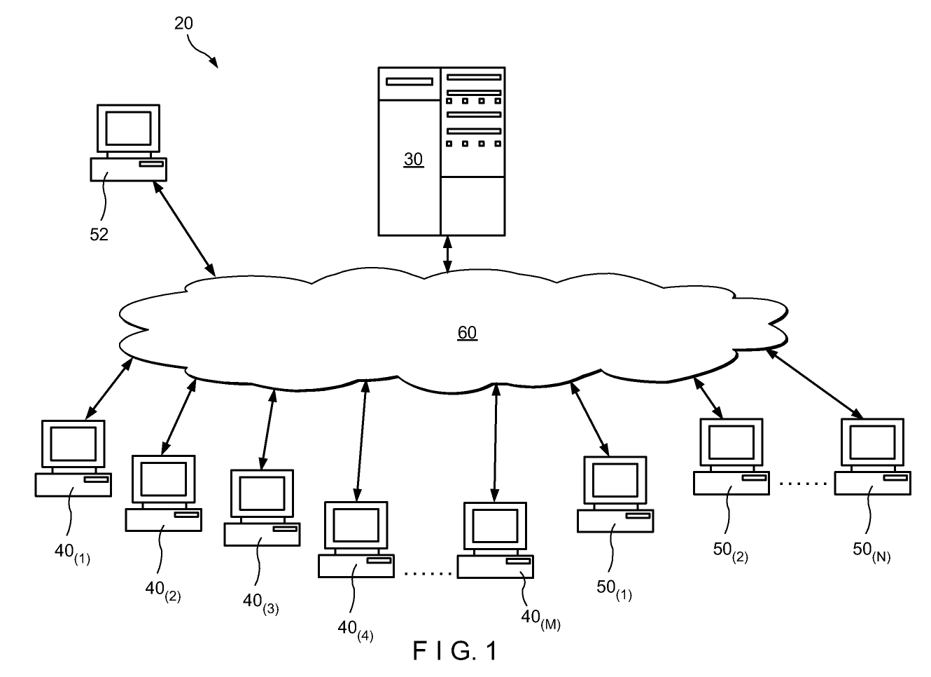

FIG. 1 illustrates a computing environment 20 under which the present invention operates. In the computing environment 20, an item management system 30 is in communication with a user computer 52, a plurality of computers 40₍₁₎ . . . 40_{(M)} which belong to friends or contacts of the user, and online merchant computers 50₍₁₎ . . . 50_{(N)} via a public computer network 60 such as the Internet. The user computer 52 interacts with online merchant computers 50 through the Internet. While the user is browsing the websites of the merchant computers 50, the item management system 30 runs applications or modules that permit the user to store data regarding items of interest at system 30 or one or more associated databases. In addition, the system 30 transmits electronic messages to contacts (e.g., friends) selected by the user for the purpose of obtaining feedback about one or more selected items stored by the user at the system 30.

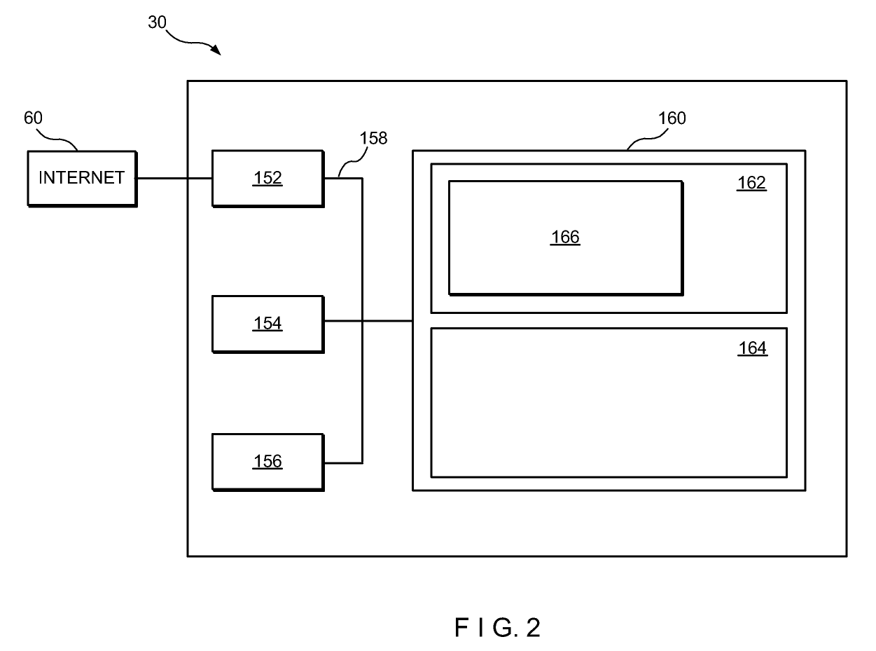

FIG. 2 illustrates in more detail a system 30 for managing items of interest for potential purchase which are selected from a plurality of online merchants 50 on the Internet. The system 30 communicates with the user computer 52 over the Internet 60 and hosts a website that provides a graphical user interface to manage selected items, e.g., a “Wishspace” site. The system 30 includes a communication device 152 that facilitates access to a network 60 such as the Internet, a processor 154 such as a central processing unit (CPU) and support circuitry 156. Components 152-156 are coupled to one another by a bus 158 which also couples to a memory 160 having program storage 162 and a data storage 164. The program storage 162 includes an item management module 166 which is the main program that interacts with users to manage, store and retrieve items of interest through a graphical user interface. The data regarding the selected items of interest by the user are stored in the data storage 164. In one embodiment, the data storage is comprised of temporary memory such as DRAM and permanent memory such as a database.

It is to be appreciated by one of ordinary skill in the art that the system 30 can be implemented as any computer such as a personal computer, minicomputer, workstation, mainframe, or a combination thereof. While system 30 is shown, for illustration purposes, as a single computer unit, it can comprise a group/farm of computers which can be scaled depending on the processing load and size of the data sets. In addition, in conjunction with, or as a substitute for, all or a portion of memory 160, one or more additional memory storage devices can be coupled to system 30 including databases for storing user information and associated item data.

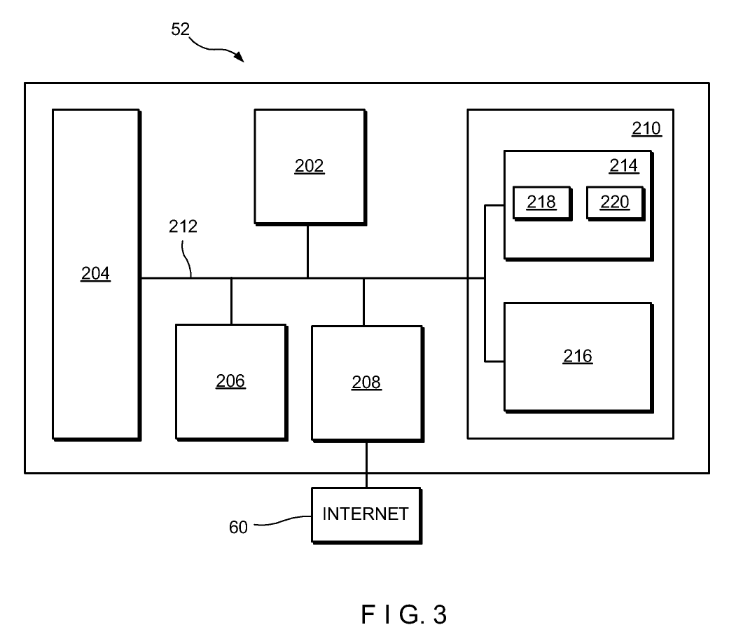

FIG. 3 is a block diagram of an exemplary user computer 52 according to an embodiment of the present invention in which the enhanced features are provided by a plug-in module to the user's browser program. User computer 52 includes a processor 202 such as a central processing unit (CPU), a display 204, an input device 206 such as a keyboard and mouse, a communication device 208 that facilitates access to a network 60 such as the Internet, and memory 210. Components 202-210 are coupled together by a bus 212. Memory 210 includes program storage memory 214 and data storage memory 216. The program storage memory 214 stores program code for a browser program 218 and for an item selection plug-in module 220. The item selection plug-in module 220 is part of the system 30 which has been downloaded to the user computer 52 and includes program code for graphically assisting the user in selecting items of interest from a merchant's website and capturing item data by parsing the layout of the displayed items. Contact computer 40 and merchant computer 50 can have identical or similar components as the user computer 52.

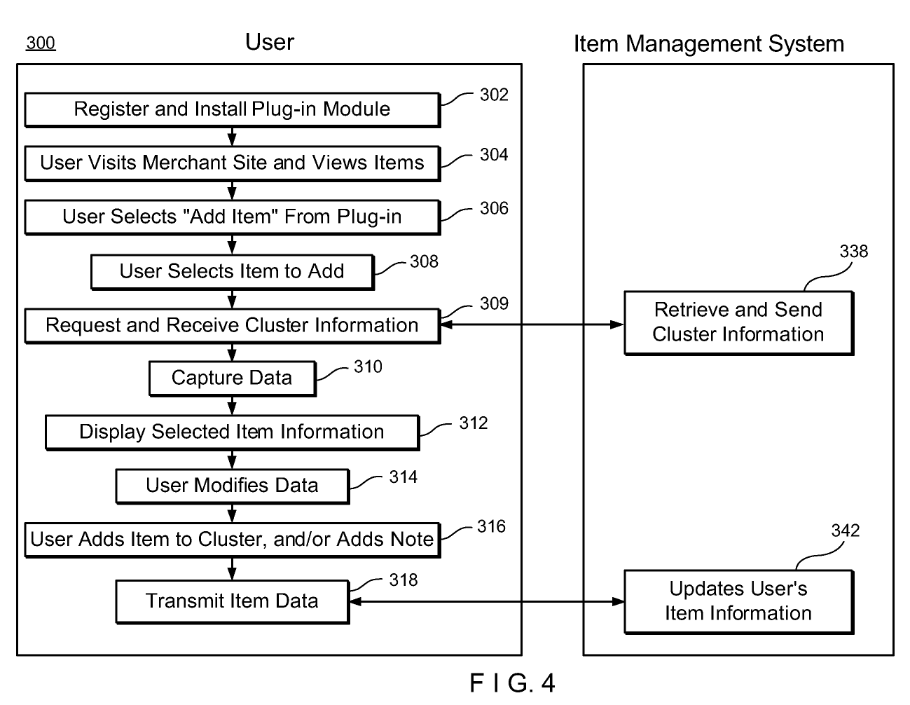

FIG. 4 is a process flowchart 300 of steps undertaken by a user and plug-in module 220 at computer 52 and by the item management module 166 in system 30 to select and store items of interest from online merchant websites. In step 302, the user through his browser program 218 visits the website of the system 30 and interacts with the item management module 166 to register for an account by supplying account information including a user identification, email address, password, and security questions. In step 302, the user also is requested to download and activate an item selection plug-in module 220. Preferably, the module 220 operates under his browser 218 of choice (e.g., Internet Explorer available from Microsoft, Firefox available from Mozilla Foundation and the like) as a plug-in module. Step 302 is a one time step and is not repeated once the plug-in module 220 is installed.

In each subsequent use of the item selection plug-in module 220, the module can automatically execute a log-in procedure required to establish a communication between the user computer 52 and the system 30. Alternatively, the user can be required to log-in to the system 30 by entering the username and password to establish a session with the item management module 166.

At step 304, a user visits a merchant web site through the Internet 60 and views items, as is conventionally known. Once a user has identified one or more items of interest that he would like to add to the Wishspace, a selection is made using the plug-in module 220 at steps 306-308.

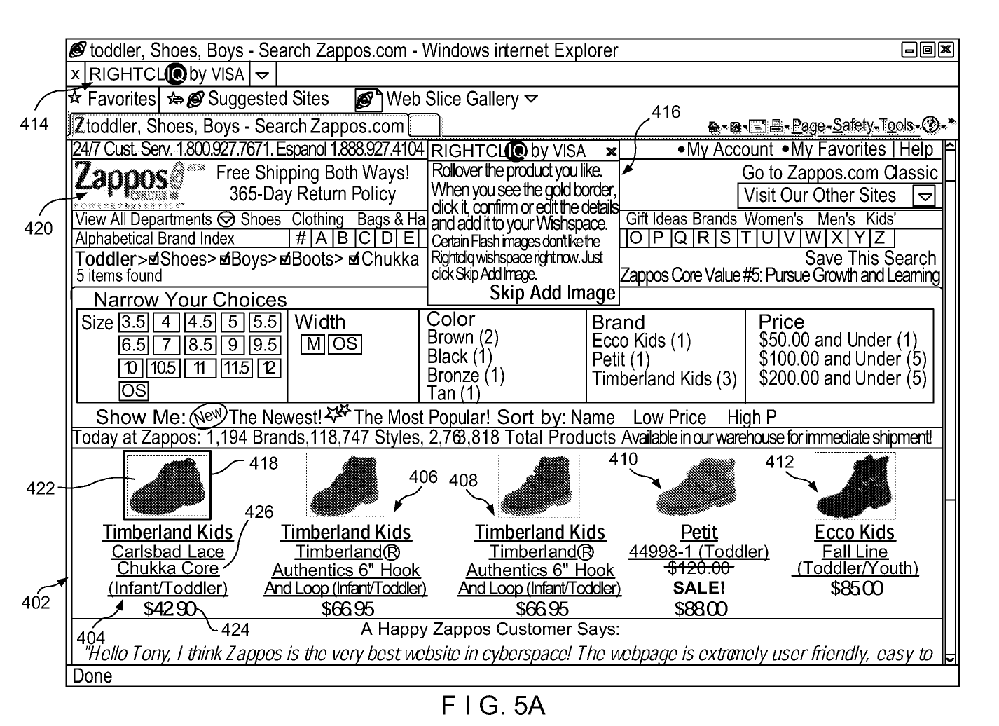

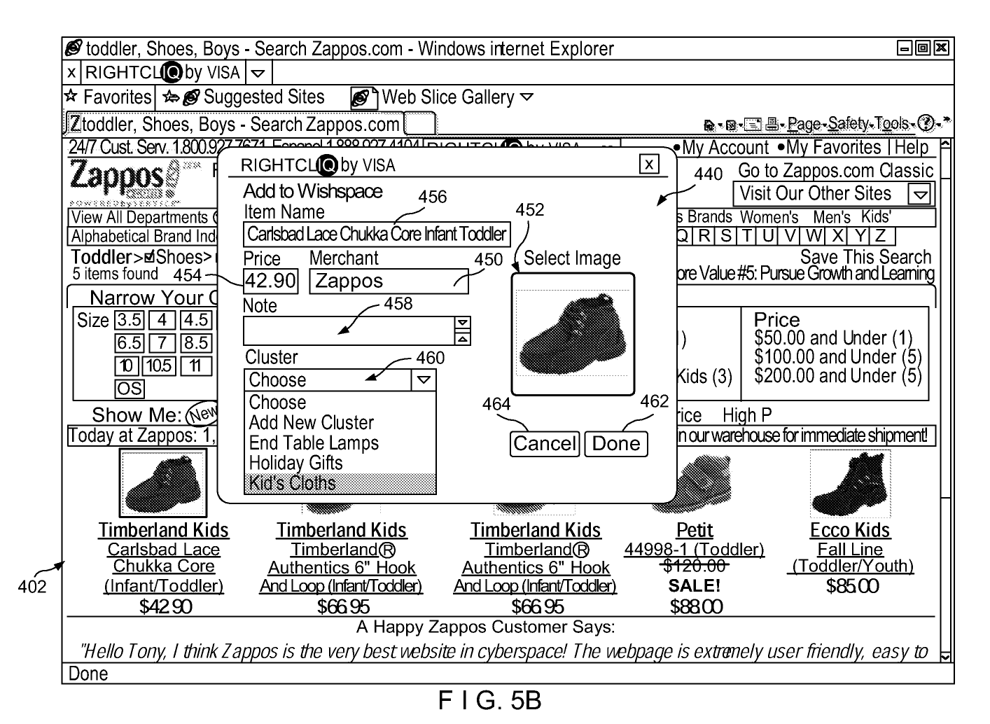

For instance, as shown in FIG. 5A, a merchant's webpage 402 is displayed, including items 404, 406, 408, 410 and 412. At step 306, the user clicks on a clickable icon 414 on the browser program 218 which then provides a pull-down menu of the item selection plug-in module 220. One of the options is to add an item to Wishspace. Selection of that option activates the item selection mode of the plug-in which causes the item selection plug-in instruction overlay/window 416 to be displayed to the user.

In one embodiment, the plug-in module modifies the HTML codes embedded in the downloaded webpage of a merchant website. The browser program 218 then interprets the modified HTML code in the web page and displays the overlay to the user.

As indicated in step 308 of FIG. 4, the user selects items to add to the Wishspace maintained by the item management module 166. In the example of FIG. 5A, the user is instructed to roll or place his mouse cursor over the image of the product item to be added and then to select the item (e.g., by clicking the mouse or pointer). As the user moves the mouse cursor over different items, a corresponding item is highlighted by the plug-in module 220. In the example shown, the highlight is a gold colored border around the image on which the mouse cursor sits. In the example of FIG. 5A, item 404 is selected, indicated by the selected item border 418.

Once an item is selected, in step 309, the plug-in module 220 transmits a request for item cluster (grouping) information from the item management module 166. A cluster is a group identifier that helps the user to group similar items of interest. In step 338, the item management module 166 receives the request, retrieves the corresponding cluster information for the user from the data storage 164, and then transmits the retrieved information to the plug-in module 220. The module 220 stores the received cluster information in the memory 216.

In step 310, the plug-in module 220 executes certain software code to try and collect item data from the merchant's website in a process called data capturing (some times known as data scraping or data scratching). This information includes the merchant name 420, a representative image 422, the item price 424 and the item name 426.

In step 312, the plug-in module 220 displays in an overlay the captured data along with a pull-down menu displaying the existing clusters.

FIG. 5B is a representative screenshot showing a selection plug-in item overlay 440, which includes item information extracted from the merchant's webpage, including the merchant's name 450, the item image 452 selected by the user, the item price 454 and the item name 456. The overlay 440 is also displaying the cluster pull-down menu 460 which is listing several clusters that the user has defined already. The pull-down menu 460 also has an option to “Add New Cluster” to define a new grouping of items.

As the item data in the overlay 440 are the best guesses of the plug-in module 220, the user is allowed to change any data directly on the overlay 440 in step 314. The user can also add notes via a field 458 in the overlay 440, and choose or add a cluster via a drop-down menu 460 in step 316.

When the user has confirmed or modified the item information, selecting the “done” icon 462 causes the plug-in module 220 to transmit the data to the item management module 162 (step 318). The transmitted data include the merchant's name 450, item image 452, item price 454, item name 456, the URL for the item and cluster and notes. In step 342, the item management module 166 receives the data and stores them in the storage 164.

If the user selects the “cancel” icon 464, the selection plug-in item overlay 440 is removed and no updates are made to the user's data of selected items in the item management module 166.

Although all of the data capturing and selection are performed by the plug-in module 220 in the embodiment shown, any or all of such processing can also be performed by the item management module 166.

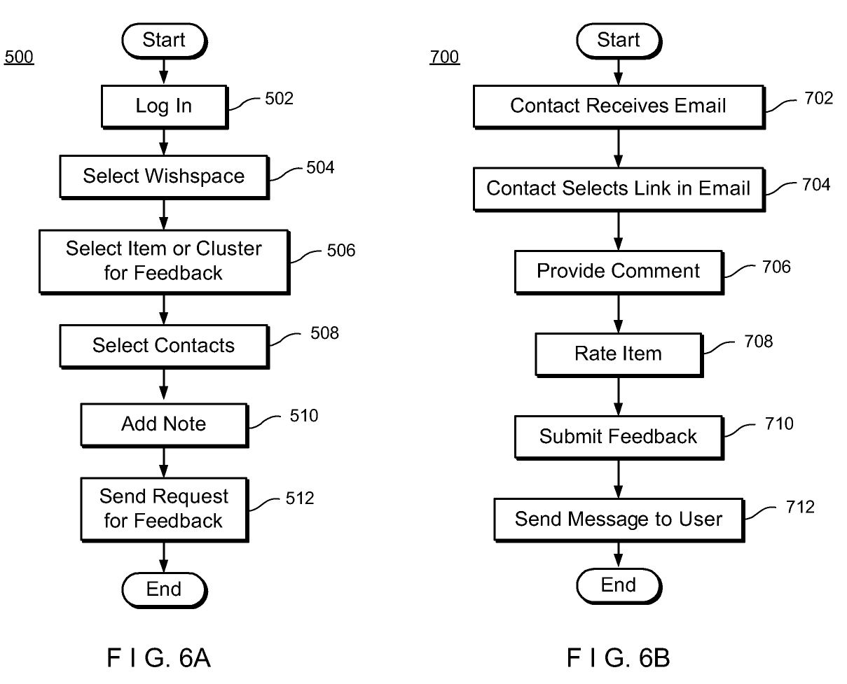

Referring to FIG. 6A, a process flowchart 500 is shown for requesting feedback on any of the items of interest according to one embodiment of the present invention. In the embodiment shown, the process 500 is performed by the item management module 166 and operates independently of the plug-in module 220 used in process 300 for selecting items from various merchant web pages. However, the plug-in module 220 can work in conjunction with the item management module 166.

At step 502, the user logs in to the item management system 30 using his login name and password in a well known manner.

The item management module 166 of the system 30 provides multiple functions for the shoppers. Among others, the module 166 allows shoppers to store product discount and reward offers, place items of interest into their Wishspace, send the item details to their friends and receive feedback, and keep track of the purchases of items.

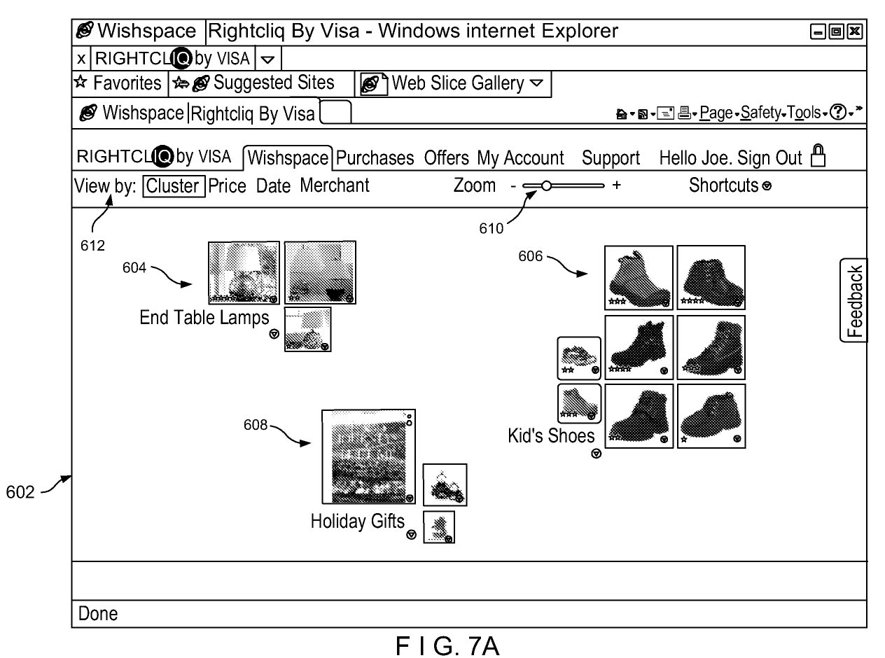

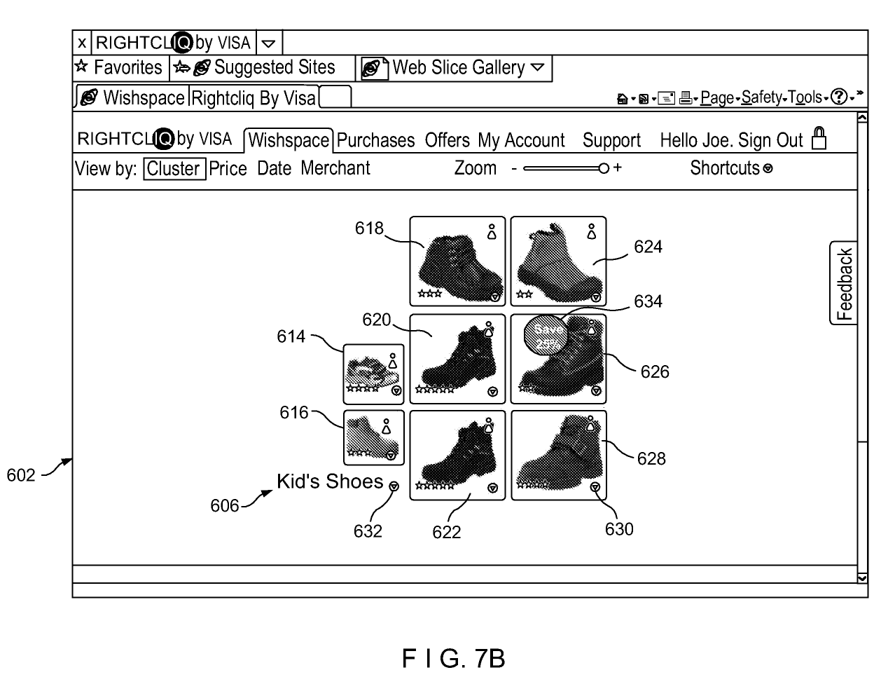

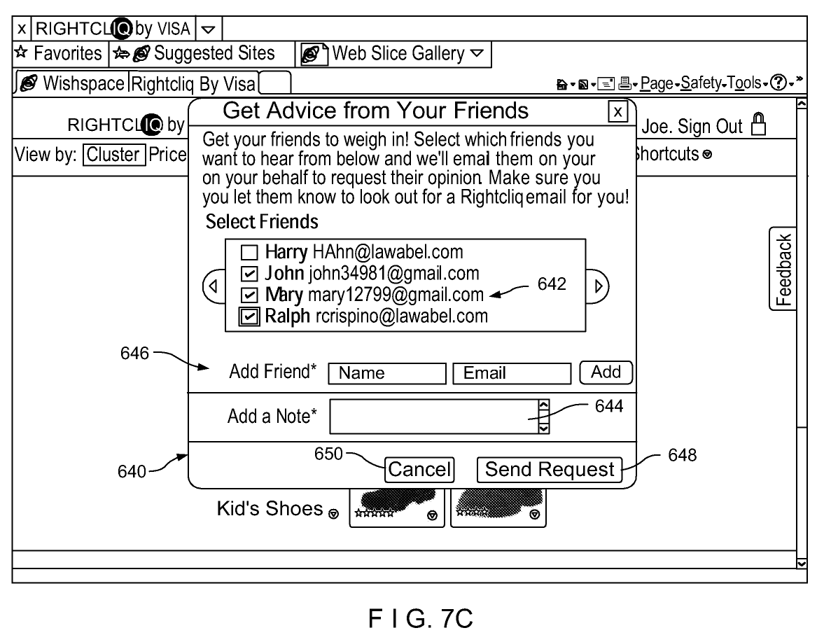

In response to the user's submission of login name and password and assuming that the login is successful, the item management module 166 retrieves all data related to the user, including the data regarding the items of interest, and stores them in a temporary memory which is a part of the storage 164 for faster access. The module 166 also transmit for display on the user's computer a web page containing a plurality of tabs including “Wishspace”, “Purchases” and “Offers” (see FIG. 7A). The Wishspace tab allows the user to maintain the stored items of interest and to send the item details to their friends and receive feedback. The Purchases tab allows the user to keep track of purchases such as shipping status and date of purchase. The Offers tab allows the user to store product discount and reward offers.

In step 504, the user selects the Wishspace tab to view the items of interest that have been saved. FIG. 7A is a representative screenshot generated by the item management module 166 when the Wishspace tab has been selected. As shown, the page 602 includes three clusters or groups 604, 606 and 608. A user can modify the view, e.g., by zooming in or out via control 610, or modifying the sorting mode 612, e.g., by cluster (as shown), by price, by date or by merchant. FIG. 7B is a representative screenshot of page 602 showing an enlarged view of cluster 606. Cluster named “Kid's Shoes” 606 includes items 614, 616, 616, 620, 622, 624, 626 and 628.

Each item and cluster has a small down arrow 632,630. When the user places a mouse cursor over the down arrow, a pull down menu appears with several options. For an item, the options include viewing details of the item, obtaining advice or feedback from friends or contacts, editing item details and deleting the item. For a cluster, the options include obtaining advice or feedback from friends or contacts on all items in the cluster, renaming the cluster name and deleting the cluster.

At step 506, the user selects an individual item or an entire cluster to request feedback. For instance, as shown in FIG. 7B, the user can select a drop-down arrow 630 associated with one of the items, or the user can select a drop-down arrow 632 associated with the cluster 606. FIG. 7C is a screenshot showing a feedback request overlay 640 when the “obtain advice” is selected from the pull-down menu of a selected item or selected cluster.

As indicated in step 508, the user can select one or more contacts that will be sent a message requesting feedback. In the embodiment shown, the system 30 uses email addresses for sending messages to the contacts of the user. As indicated in step 510 in FIG. 6A, notes can be added to the message. As shown in FIG. 7C, the feedback request overlay 640 includes a listing of previously stored contacts 642 which can be individually selected, a notes field 644, and an option to add further contacts via fields 646. When the user has confirmed or modified the feedback requests to be sent, in step 512, selecting the “Send Requests” icon 648 causes the email message to be sent to the selected contacts by the item management module 166. While the embodiment shown utilizes emails, other electronic communication methods such as SMS (short message service) text messages can be used.

If the user selects the “Cancel” icon 650, the feedback request overlay 640 is removed and no message is sent. In certain embodiments, the request for feedback for a particular item can be carried out by a similar process using the item selection plug-in module 220 when items are selected for inclusion in the item data associated with the item management module 166.

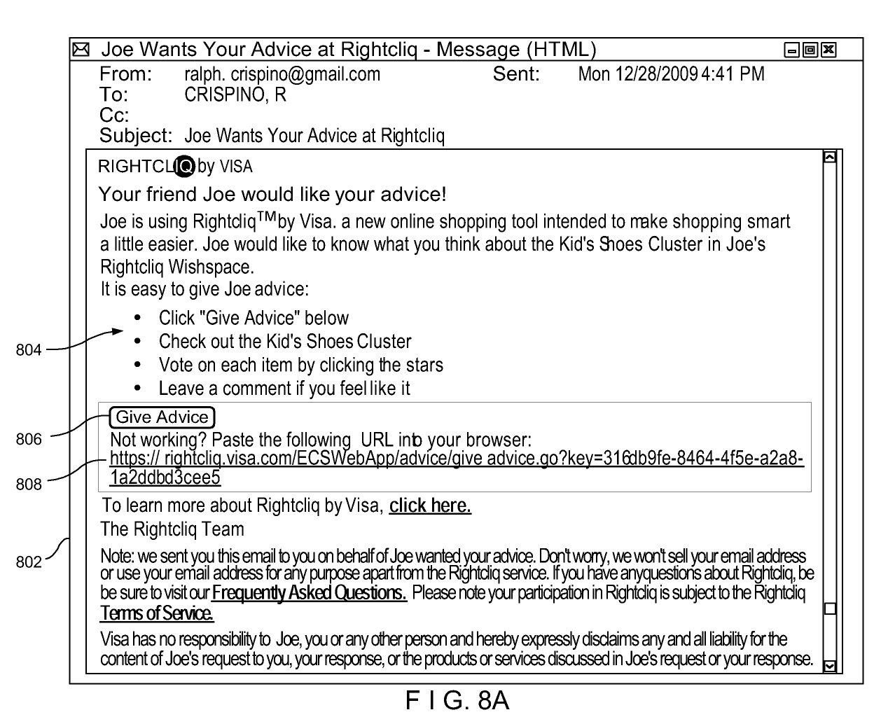

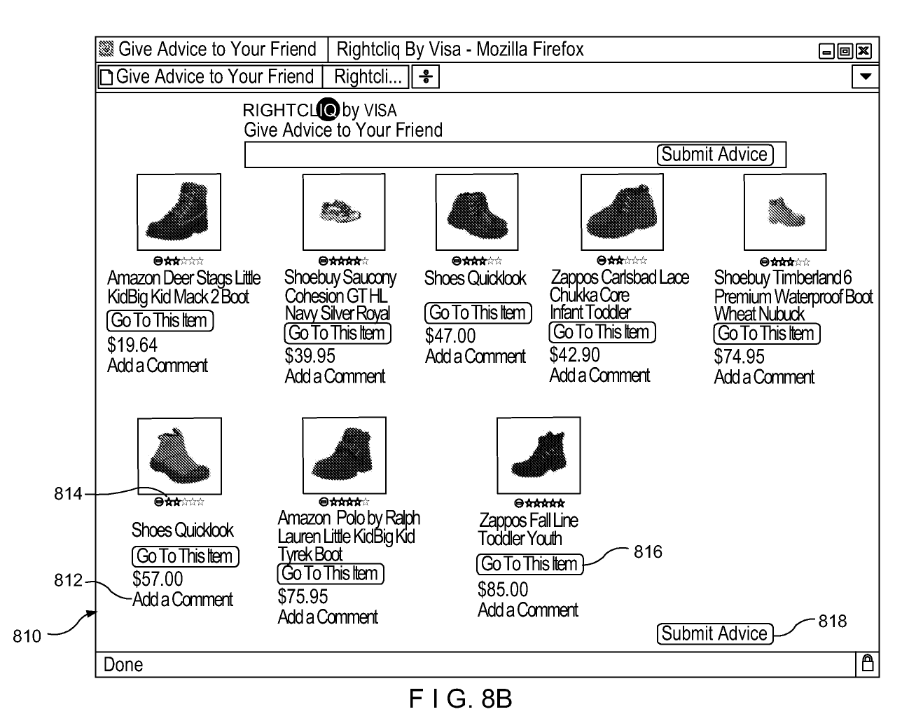

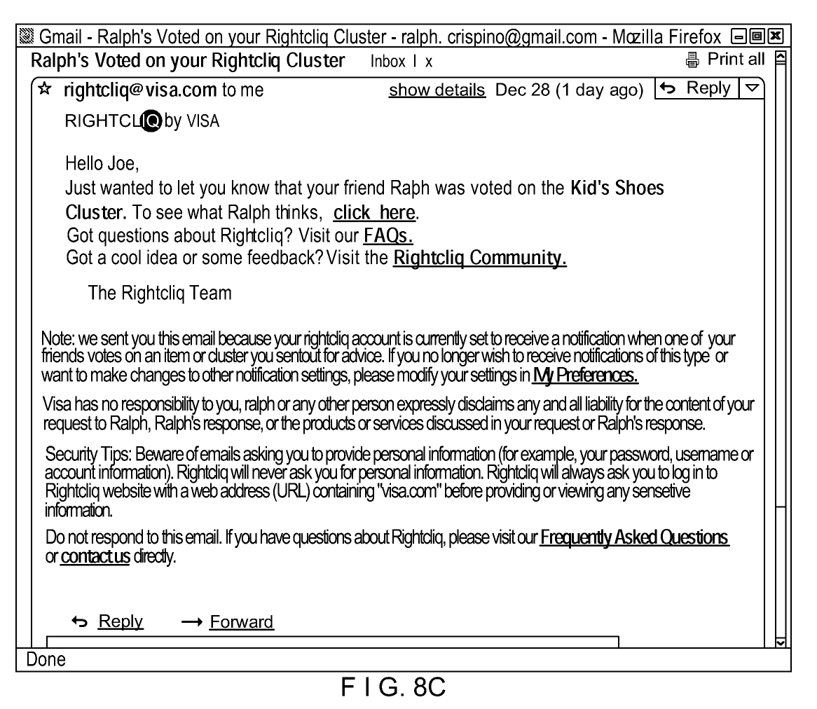

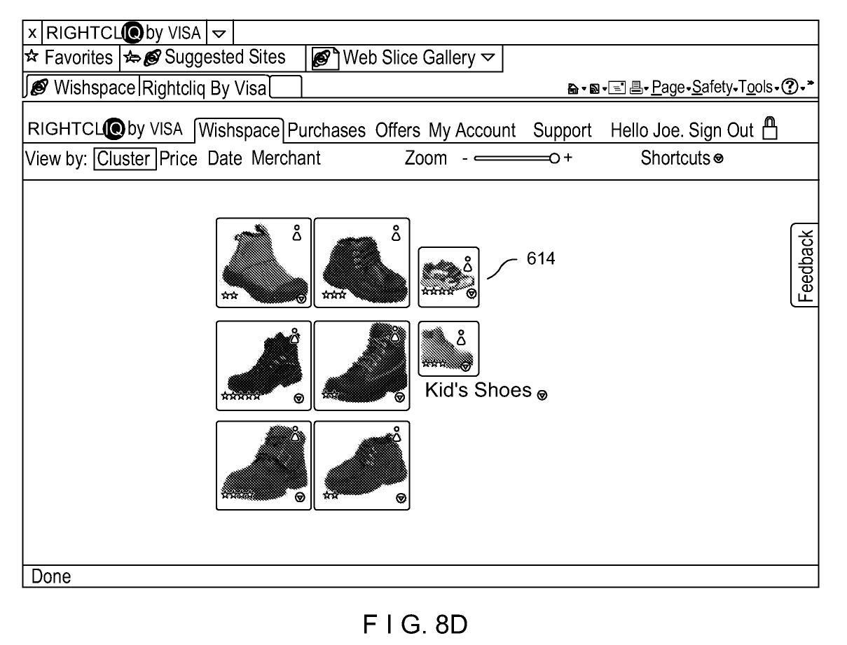

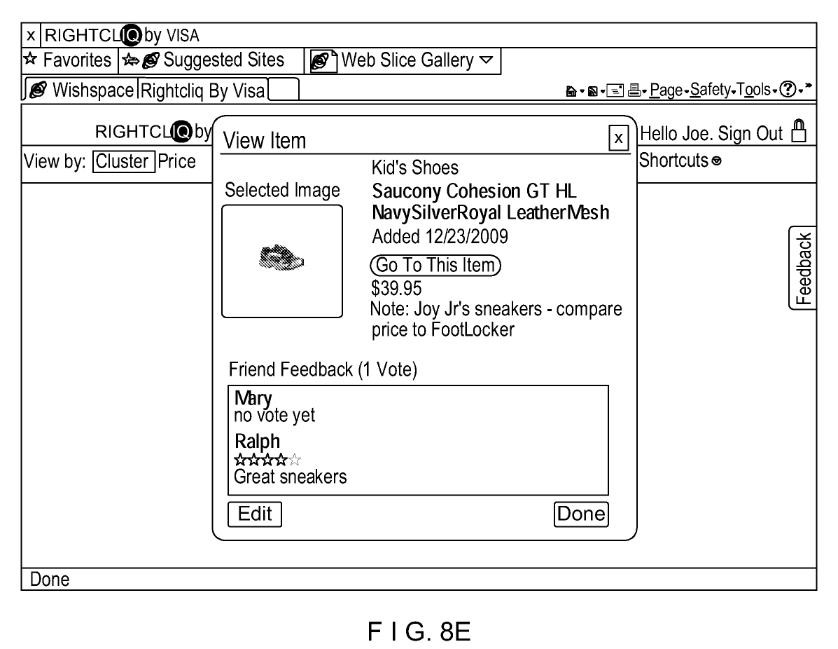

Referring to FIG. 6B, a process flowchart 700 is shown for obtaining feedback from the user's contacts according to one embodiment of the present invention. Each contact specified by the user receives an email as indicated in step 702. FIG. 8A is a representative email message 802 that is received by each user specified contact. Note that the item management module 166 inserts the user's email address in the “From:” field making it appear as if the email is coming directly from the user “Joe”. However, the email is automatically transmitted from the item management module 166 of the present invention.

The email message 802 provides instructions 804 to the contact, and a “Give Advice” icon 806 that is associated with a sufficiently unique address link that serves as a key identifying the contact to which the request for feedback is directed, the item or cluster, and the user that requested the feedback. In the event that the icon 806 is not operable, e.g., due to a firewall or other security measure operating on the contact's computer, the address in the form of a uniform resource locator (URL) 808 is also provided. In this convenient manner, the contact need not log in, register with or create an account with the item management system 30 to provide the requested feedback/advice.

When the recipient contact selects the link 806 in the email by clicking on it with a mouse or enters the URL 808 into his browser program, indicated in step 704 of FIG. 6B, the contact is directed to the web site of the item management system 30. FIG. 8B is a representative screenshot 810 of the several items in the cluster for which the user requested feedback. As indicated in step 706 of FIG. 6B, the contact is provided with the option of adding a comment regarding each of the items (link 812 in FIG. 8B) which can be a text comment. In addition, as indicated in step 708 of FIG. 6B, the contact can rate one or more of the items. In the embodiment shown, the rating is the number of stars 814 with predetermined five stars being the highest. If the contact seeks additional information about the item prior to commenting, he can select link 816 (“Go To This Item”) and he will be hyperlinked to the merchant's web page with the details for that particular item. Once the contact has completed entering comments and rating the item, in step 710 of FIG. 6B, the feedback can be submitted by selecting link 818 shown in FIG. 8B. The received comment and rating information are stored along with the item information associated with the user's account in the storage 164 by the item management module 166.

In step 712, an email message is sent to the user by the item management module 166, indicating that one of the selected contacts has provided a feedback which may include comments or ratings or both for one or more items. FIG. 8C is a representative feedback email to the user indicating that a contact has provided a rating (voting) on an item.

The email provides a clickable hyperlink that takes the user to a web site containing the item or cluster of items in question (see FIG. 8D) once the login information to the system 30 is provided. Alternatively, the user can view the feedback by logging into the item management system 30 without relying on the hyperlink in the received feedback email and by selecting the Wishspace tab. FIG. 8D is an exemplary screen shot of a cluster of items containing feedback ratings for the associated items (see FIG. 7B which does not yet have any feedback ratings). For example, FIG. 8D shows a cluster named “Kid's Shoes” and shoe 614 has an average feedback rating of 4 stars. Moving a mouse cursor over an item image triggers a display of item details inside the image such as the item description, price and the number of contacts that have left a feedback rating.

Moving a mouse cursor over a down arrow inside the associated item image triggers a pull-down menu. When a “View Item Details” is selected, the item management module displays a View Item window (overlay) as shown in FIG. 8E. The overlay displays the item description and the feedback comments and ratings from all of the friends (contacts) from whom feedback was requested. For example, overlay shows that Mary has not yet responded to the request for feedback while Ralph has rated the shoe 614 four stars and a text comment of “Great Sneakers”.

Once items are included in the user's Wishspace, there are a number of options provided to the user through other enhanced features according to the present invention. One of the features is that the item management module 166 constantly tracks the item details at the merchant online sites. The tracking of information can be done with or without the assistance of the online merchants. If any of the items of interest in the user's Wishspace has been changed at the associated merchant website, the item management module updates the changed data for the user in storage 164. When the item is subsequently viewed, the item management module 166 will show the item with a note stating that the item information has been changed.

For instance, the web page in FIG. 7B shows a notification 634 indicating that the offered price for the item 626 is on sale with a 25% discount. At the option of the user, the item management module 166 can notify the user of any change such as the price change by sending a message such as an email or SMS (short message service) message to the user.

The user may configure its personal settings so that a specific change on an individual item triggers an email message or a general change on any item triggers a message. For example, the user account in the system 30 can be set up, through the item management module 166, to send an email to the user whenever a price on any item of interest drops. In some embodiments, with the consent of the user, merchants may be provided certain information regarding the items in the user's selected items. This information may be useful to the merchants for gauging the demand for the items. In such embodiments, merchants may be given an opportunity to make selective notifications to the user. This feature may give merchants an added ability to make appropriate offers, and may give the users enhanced purchasing options.

Any of the overlays/windows (e.g., overlay 416, 440, 640) described herein can be generated by the action of either the plug-in module 220 or item management module 166 or both. In one embodiment, the overlays are generated by inserting or modifying appropriate code (e.g., HTML codes) to the received browser webpage to include the overlay 416 in the user's browser window. In that embodiment, the browser program 218 interpreting the HTML codes generates the overlay.

As described above, the present invention provides a convenient and flexible system for allowing a shopper to add and manage items of interest to a wish list from any online merchant without being restricted to a single merchant. The present invention also provides a convenient system for the shopper to automatically request and receive feedbacks on his wish list items from friends and colleagues. In this way, the shoppers make purchases with confidence knowing that the items being purchased have received positive feedback and the online merchants benefit from increased sales.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

What is claimed is:

1. A system for managing items of interest for potential purchase from a plurality of online merchants, the system comprising:
a memory operable to store data regarding the items of interest which are selected by a user from one or more online merchants;
a processor coupled to the memory; and
an item management module executable by the processor and adapted to send an electronic message to one or more user-selected contacts containing a request for feedback on one or more selected items of interest and to store the feedback from the contacts in the memory.

2. The system of claim 1, wherein the item management module is adapted to send the electronic message containing a link that allows the user-selected contacts to submit a feedback without registering with the system.

3. The system of claim 2, wherein the item management module is adapted to generate the link containing sufficient information to identify the user, the user-specified contact and the item of interest for which a feedback is requested.

4. The system of claim 1, wherein the item management module is adapted to store the data regarding the items of interest in a cluster defined by the user and to send the electronic message containing the request for feedback on the cluster of items.

5. The system of claim 1, wherein the item management module is adapted to store in the memory a comment and a rating of the item of interest from the user-specified contact.

6. The system of claim 1, wherein the item management module is adapted to send an electronic communication to the user indicating receipt of a feedback from the user-specified contact.

7. The system of claim 1, wherein the item management module is adapted to display a list of previously defined contacts for selection by the user.

8. The system of claim 1, further comprising an item selection module adapted to be executed in a user computer and to automatically capture data regarding an item of interest from an online merchant web page being viewed by the user.

9. The system of claim 8, wherein the item selection module is adapted to send the captured data to the item management module over a public computer network.

10. The system of claim 8, wherein the item selection module is adapted to highlight a corresponding item of interest among a plurality of displayed items of interest as the user moves a cursor over the displayed items.

11. The system of claim 1, wherein the item management module monitors the change in data regarding the stored items of interest and updates the corresponding data in the memory.

12. The system of claim 11, wherein the item management module is adapted to receive a user-specified notification criterion for the change in price data regarding an item of interest and to send an electronic communication to the user upon satisfaction of the notification criterion.

13. A system for managing items of interest for potential purchase which are selected from a plurality of online merchants present on a computer network, the system comprising:
an item selection module adapted to be executed in a user computer and to capture data regarding the items of interest from web pages of the online merchants;
a memory operable to store the captured data regarding the items of interest;
a processor coupled to the memory; and
an item management module executable by the processor and adapted to:
receive the captured data from the item selection module for storage in the memory;
responsive to a user request, send an electronic message to one or more user-selected contacts containing a request for feedback on one or more selected items of interest; and
store the feedback from the user-selected contacts in the memory.

14. The system of claim 13, wherein the item management module is adapted to send the electronic message containing a link that allows the user-selected contacts to submit a feedback without registering with the system.

15. The system of claim 14, wherein the item management module is adapted to generate the link containing sufficient information to identify the user, the user-specified contact and the item of interest for which a feedback is requested.

16. The system of claim 13, wherein the item management module is adapted to send an electronic communication to the user indicating receipt of a feedback from the user-specified contact.

17. The system of claim 13, wherein the item management module is adapted to display a list of previously defined contacts for selection by the user.

18. The system of claim 13, wherein the item selection module is adapted to highlight a corresponding item of interest among a plurality of displayed items of interest as the user moves a cursor over the displayed items.

19. The system of claim 13, wherein the item management module monitors the change in data regarding the stored items of interest and updates the corresponding data in the memory.

20. The system of claim 19, wherein the item management module is adapted to receive a user-specified notification criterion for the change in price data regarding an item of interest and to send an electronic communication to the user upon satisfaction of the notification criterion.

21. A method for managing items of interest for potential purchase from a plurality of online merchants, the method comprising:
storing, in a memory, data regarding the items of interest which are selected by a user from one or more online merchants;
send, by an item management module executable by a processor, an electronic message to one or more user-selected contacts containing a request for feedback on one or more selected items of interest; and
storing the feedback from the contacts in the memory.

22. The method of claim 21, wherein the step of sending includes sending the electronic message containing a link that allows the user-selected contacts to submit a feedback without registration.

23. The method of claim 22, further comprising generating the link containing sufficient information to identify the user, the user-specified contact and the item of interest for which a feedback is requested.

24. The method of claim 21, wherein:
the step of storing data includes storing the data regarding the items of interest in a cluster defined by the user; and
the step of sending includes sending the electronic message containing the request for feedback on the cluster of items.

25. The method of claim 21, further comprising:
automatically capturing, by an item selection module adapted to be executed in a user computer, data regarding an item of interest from an online merchant web page being viewed by the user; and
receiving, from the item selection module, the captured data over a public computer network.

26. The method of claim 21, further comprising highlighting, by the item selection module, a corresponding item of interest among a plurality of displayed items of interest as the user moves a cursor over the displayed items.

27. The method of claim 21, further comprising monitoring the change in data regarding the stored items of interest and updating the corresponding data in the memory.

28. The method of claim 27, further comprising:
storing a user-specified notification criterion for the change in price data regarding an item of interest; and
sending an electronic communication to the user upon satisfaction of the stored notification criterion.
